(19) United States
(12) Patent Application Publication
(10) Pub. No.: US 2022/0281078 A1
(43) Pub. Date: Sep. 8, 2022

(54) WRENCH WITH SELECTABLE DRIVE HEADS

(71) Applicant: INFAR INDUSTRIAL CO., LTD., Chang-Hua County (TW)

(72) Inventor: Tai Hung Chen, Chang-Hua County (TW)

(21) Appl. No.: 17/680,549

(22) Filed: Feb. 25, 2022

(30) Foreign Application Priority Data
Mar. 2, 2021 (TW) 110107324

(51) Int. Cl. B25B 13/46; B25B 23/00

(52) U.S. Cl. CPC B25B 13/463; B25B 23/0035

(57) ABSTRACT

A wrench includes a body and a ratchet ring pivotally mounted on the body. The ratchet ring has a through hole and a side hole. The side hole includes a restrainer disposed therein. Further, a drive rod with drive heads is disposed in the through hole and movable between a first position and a second position. The drive rod has an outer periphery which has a long slot. The restrainer includes an end protruding in the long slot. The long slot extends from a first end to a second end. The drive rod is selectively disposed in the first position in which the restrainer is held by the first end of the long slot. The drive rod is selectively disposed in the second position in which the restrainer is held by the second end of the long slot.

### BACKGROUND OF THE INVENTION

### 1. Field of the Invention

The present invention relates to a wrench and, particularly, to a wrench with selectable drive heads.

### 2. Description of the Related Art

Refer to TW Pat. No. M527810, a telescopic wrench with double ratchet heads includes a telescopic rod which includes a first rod and a second rod being retractable with respect to one another, a first ratchet head arranged at one end of the first rod, a second ratchet head arranged at one end of the second rod which is distal to the first rod and disposed oppositely to the first ratchet head, and a positioning structure arranged between the first and the second rods to limit telescopic positions of the first and the second rods. The first and the second ratchet heads are respectively provided for engaging sockets of different sizes. The first and the second ratchet heads are engagable with sockets of different sizes. However, each of the first and the second ratchet heads includes a ratchet mechanism and thus the wrench has more complex structures and higher cost of manufacture.

The present invention is, therefore, intended to obviate or at least alleviate the problems encountered in the prior art.

### SUMMARY OF THE INVENTION

According to the present invention, a wrench with selectable drive heads includes a body, a ratchet ring, and a drive rod. The ratchet ring is pivotally mounted on the body and pivotal about an axis. The ratchet ring has a through hole extending along the axis and a side hole extending radially to the axis. The side hole includes a restrainer disposed therein. The drive rod with drive heads is disposed in the through hole and movable between a first position and a second position along the axis. The drive rod has an outer periphery which is radial to the axis and has a long slot. The restrainer includes an end protruding in the long slot. The long slot extends from a first end to a second end along the axis. The drive rod is selectively disposed in the first position in which the restrainer is held by the first end of the long slot. The drive rod is selectively disposed in the second position in which the restrainer is held by the second end of the long slot.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing other structures, methods and systems for carrying out the several purposes of the present invention. It is important, therefore, that the claims be regarded as including such equivalent constructions insofar as they do not depart from the spirit and scope of the present invention.

Further, the purpose of the abstract is to enable the public generally, and especially scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a wrench with selectable drive heads in accordance with a first embodiment of the present invention.

FIG. 2 is an exploded perspective view of the wrench of FIG. 1.

FIG. 3 is a cross-sectional view of the wrench of FIG. 1 and shows a head in a first position.

FIG. 4 is another cross-sectional view of the wrench of FIG. 1 and show the head in the first position.

FIG. 5 is a cross-sectional view of the wrench of FIG. 1 and shows the head in a second position.

FIG. 6 another cross-sectional view of the wrench of FIG. 1 and shows the head in the second position.

FIG. 7 is an exploded perspective view of a wrench with selectable drive heads in accordance with a second embodiment of the present invention.

FIG. 8 is a cross-sectional view of the wrench of FIG. 7

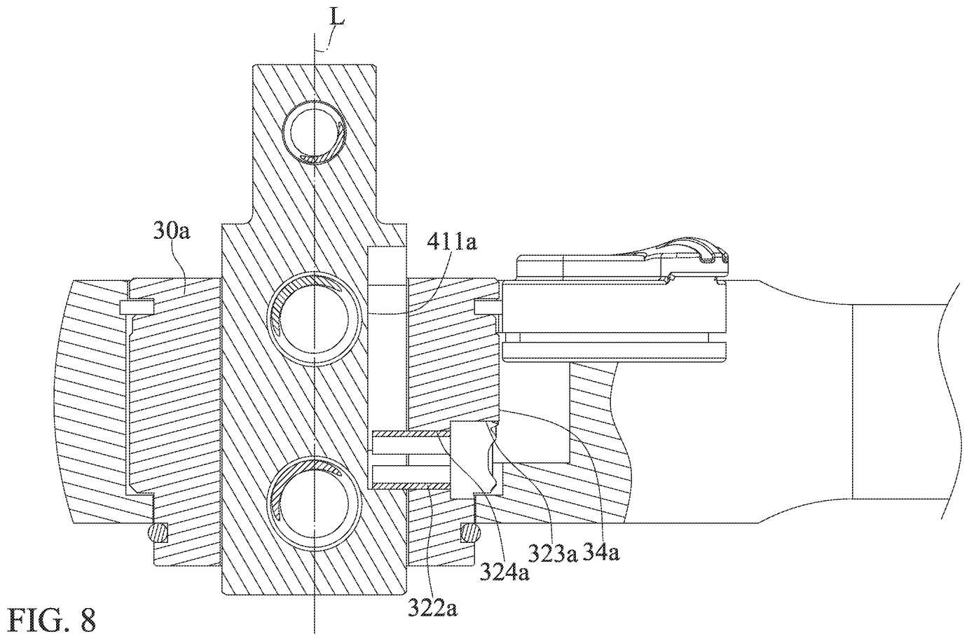

### DETAILED DESCRIPTION OF THE INVENTION

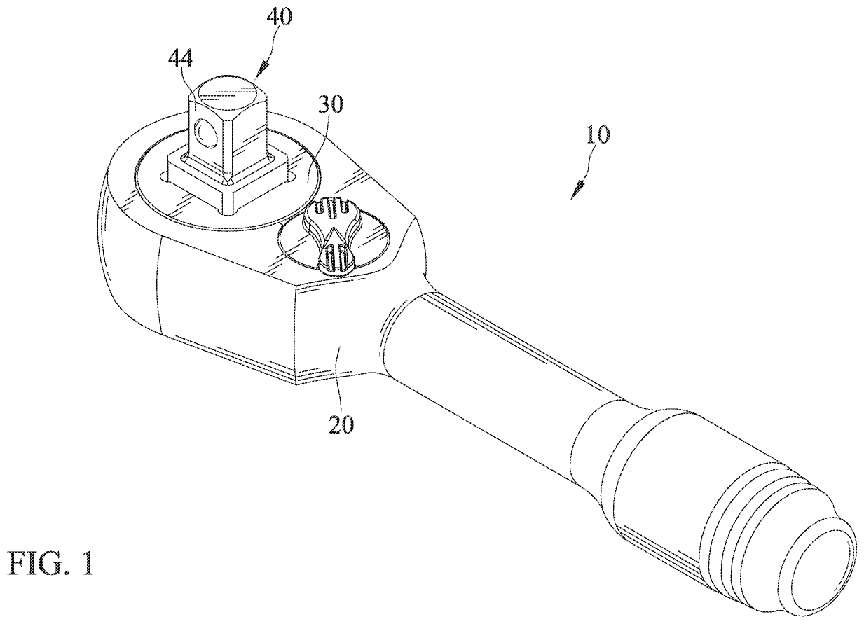

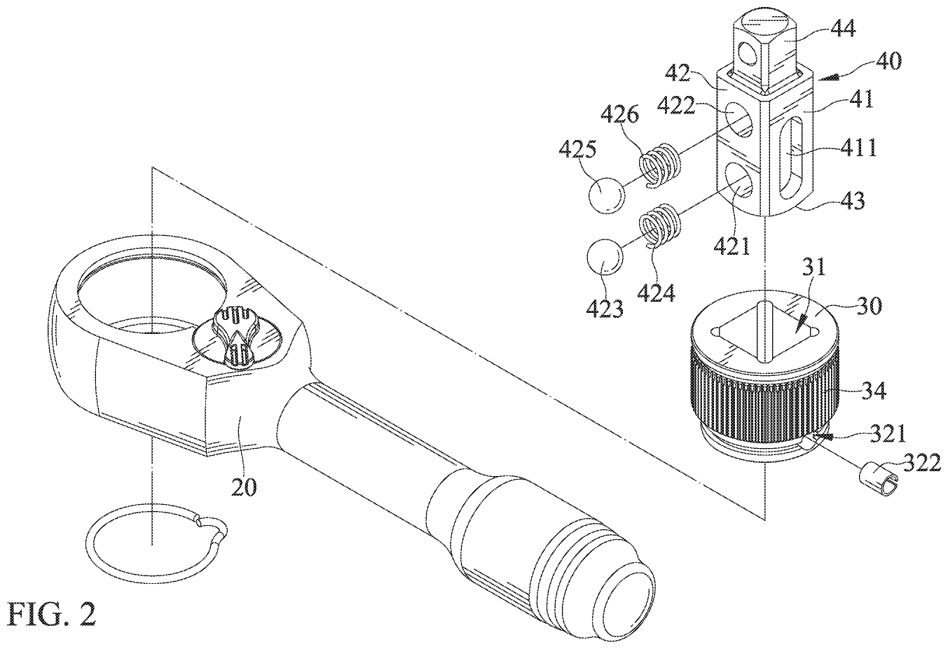

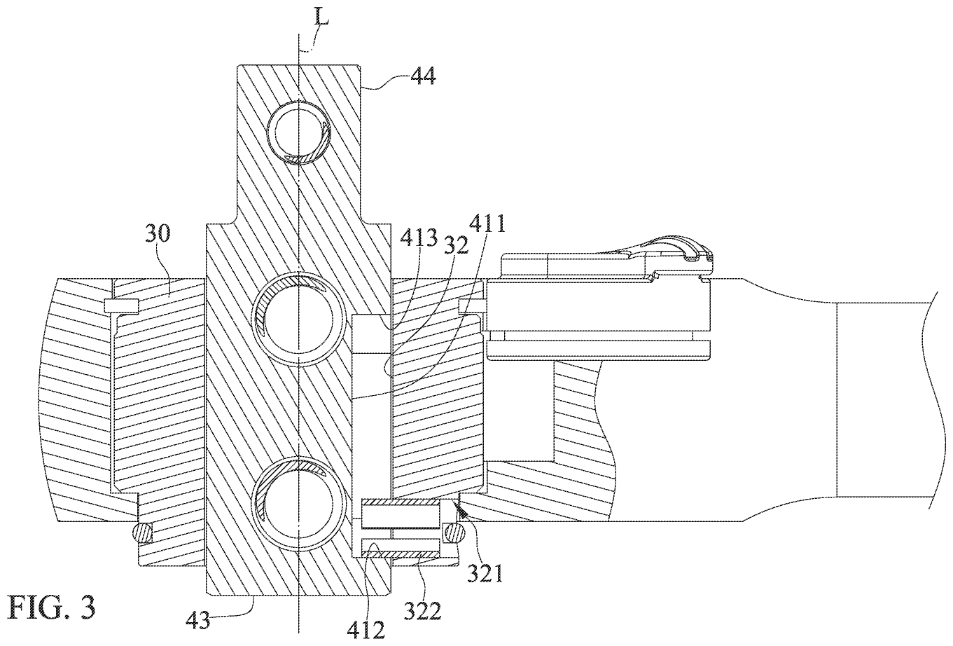

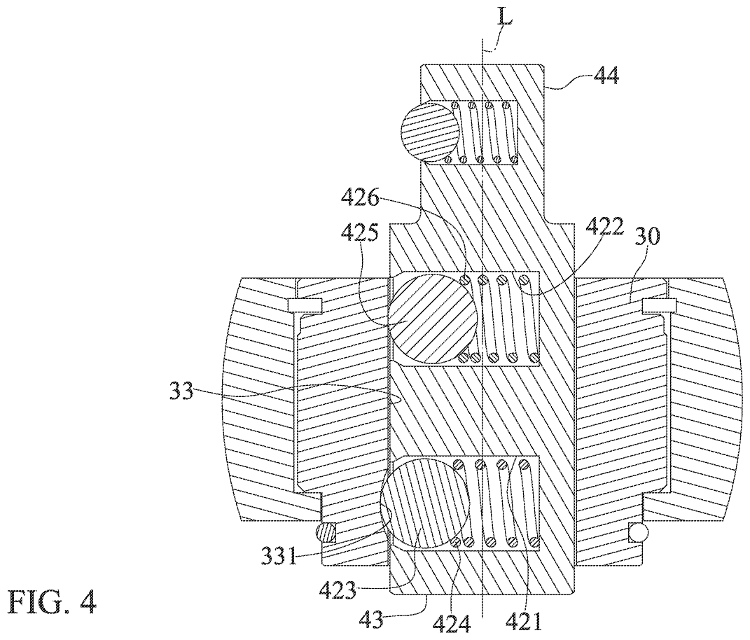

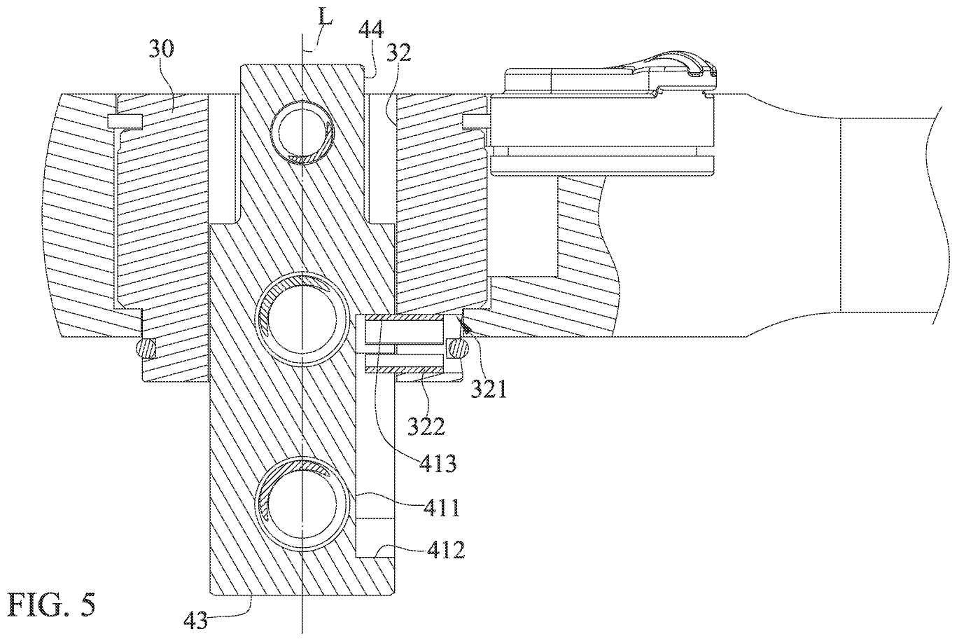

FIGS. 1 through 6 show a wrench with selectable drive heads in accordance with a first embodiment of the present invention. The wrench 10 includes a body 20, a ratchet ring 30, and a drive rod 40.

The ratchet ring 30 is pivotally mounted on the body 20 and pivotal about an axis L. The ratchet ring 30 has a through hole 31 extending along the axis L. The through hole 31 has an inner periphery including a first inner surface 32. The ratchet ring 30 also has a side hole 321 extending radially to the axis L. The side hole 321 extends to the inner surface 32. The side hole 321 includes a restrainer 322 disposed therein. The restrainer 322 is a spring pin. Preferably, the restrainer 322 is a slotted spring pin.

The drive rod 40 with drive heads is disposed in the through hole 31 and movable between a first position and a second position along the axis L. The drive rod 40 has an outer periphery which is radial to the axis L. The outer periphery includes a first peripheral surface 41. The drive rod 40 has a long slot 411 extending on the first peripheral surface 41. The restrainer 322 includes an end protruding in the long slot 411. The long slot 411 extends from a first end 412 to a second end 413 along the axis L. The drive rod 40 is selectively disposed in the first position in which the restrainer 322 is held by the first end 412 of the long slot 411, and the second position in which the restrainer 322 is held by the second end 413 of the long slot 411. The long slot 411 is long such that the side hole 321 is partially closed by the body 20 when the drive rod 40 is selectively disposed in the first position or the second position.

The side hole 321 has an end connected with the through hole 31. The ratchet ring 30 has an outer periphery which is radial to the axis L and the side hole 321 has another end connected with the outer periphery of the ratchet ring 30. The ratchet ring 30 includes teeth 34 disposed annularly along the outer periphery thereof. The side hole 321 is not connected with the teeth 34.

The inner periphery of the through hole 31 includes a second inner surface 33 and a positioning groove 331 extends on the second inner surface 33 and is radial to the axis L. The positioning groove 331 has an inner peripheral edge which forms a concave surface. The outer periphery of the drive rod 40 includes a second peripheral surface 42 and a first and a second hole 421 and 422 extend on the second peripheral surface 42. The first hole 421 receives a first detent 423 and a first resilient member 424. The first resilient member 424 has an end abutting the bottom of the first hole 421 and another end abutting the first detent 423. The second hole 422 receives a second detent 425 and a second resilient member 426. The second resilient member 426 has an end abutting the bottom of the second hole 422 and another end abutting the second detent 425. The first and the second detents 423 and 425 are spherical. The first and the second detents 423 and 425 selectively engages in the positioning groove 331. When the drive rod 40 is in the first position, the first detent 423 corresponds to and engages in the positioning groove 331. Ehen the drive rod 40 is in the second position, the second detent 425 corresponds to and engages in the positioning groove 331.

The drive rod 40, along the axial direction of the axis L, has an end provided with a first drive head 43 and another end provided with a second drive head 44. The first end 412 of the long slot 411 and the first detent 423 are adjacent to the first drive head 43. The second end 413 of the long slot 411 and the second detent 425 are adjacent to the second drive head 44. The second drive head 44 has a smaller width extending radially to the axis L than the first drive head 43.

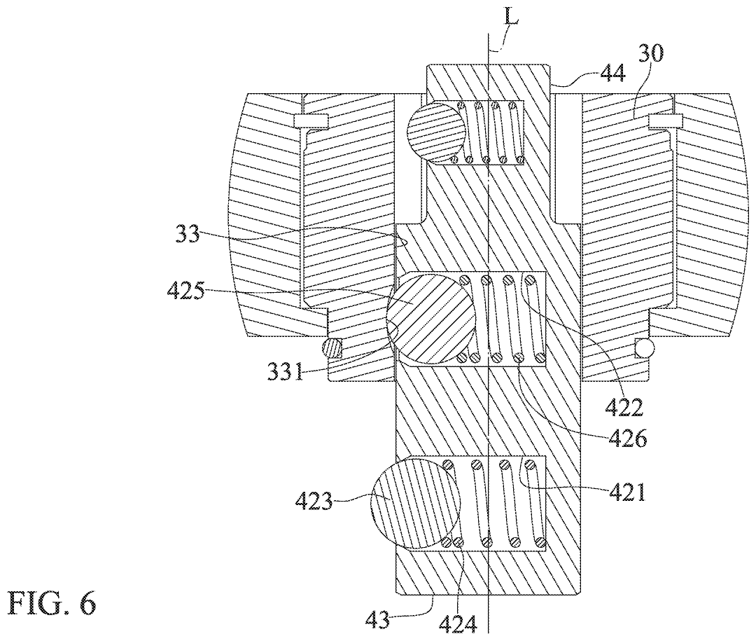

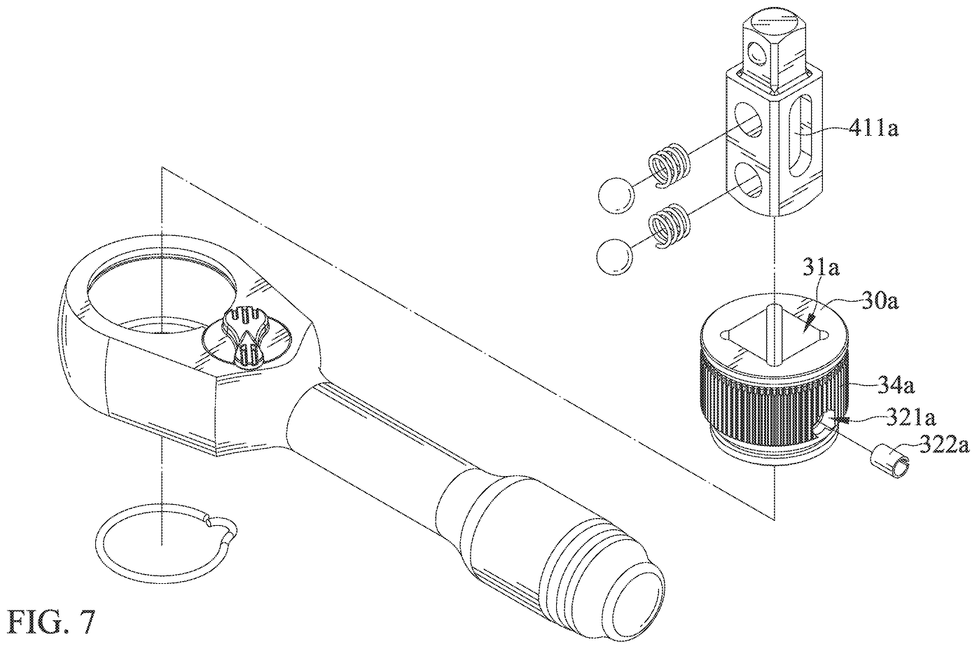

FIGS. 6 and 7 show wrench with selectable drive heads in accordance with a second embodiment of the present invention, and the same numbers are used to correlate similar components of the first embodiment, but bearing a letter a. The second embodiment is substantially the same as the first embodiment, except that a ratchet ring 30a has an outer periphery which is radial to the axis L and includes teeth 34a disposed annularly therealong, and an end of a side hole 321a, which is connected to the outer peripheral of the ratchet ring 30a, has an edge only partially connected to the ring teeth 34a. Further, the side hole 321a has an inner periphery including a wide section 323a and a narrow section 324a. The wide section 323a is adjacent to the outer periphery of the ratchet ring 30a. The narrow section 324a has a radial width smaller than the wide section 323a. The narrow section 324a is adjacent to a through hole 31a. Further, a restrainer 322a is arranged in the narrow section 324a. The restrainer 322a has an end, which is opposite to the long slot 411a, aligned with a surface of the inner periphery between the wide section 323a and the narrow section 324a. The restrainer 322 is inserted into the narrow section 324a in a tight fitting manner.

In view of the foregoing, the drive heads 43 and 44 of the wrench 10 is selectively deployable to engage with sockets of different hole sizes.

The foregoing is merely illustrative of the principles of this invention and various modifications can be made by those skilled in the art without departing from the scope and spirit of the invention.

What is claimed is:

1. A wrench with selectable drive heads comprising:
a body;
a ratchet ring, wherein the ratchet ring is pivotally mounted on the body and pivotal about an axis, wherein the ratchet ring has a through hole extending along the axis and a side hole extending radially to the axis, and wherein the side hole includes a restrainer disposed therein; and
a drive rod with drive heads, wherein the drive rod is disposed in the through hole and movable between a first position and a second position along the axis, wherein the drive rod has an outer periphery which is radial to the axis and has a long slot, wherein the restrainer includes an end protruding in the long slot, wherein the long slot extends from a first end to a second end along the axis, wherein the drive rod is selectively disposed in the first position in which the restrainer is held by the first end of the long slot, and wherein the drive rod is selectively disposed in the second position in which the restrainer is held by the second end of the long slot.

2. The wrench as claimed in claim 1, wherein the side hole has an end connected with the through hole, and wherein the ratchet ring has an outer periphery which is radial to the axis and the side hole has another end connected with the outer periphery of the ratchet ring.

3. The wrench as claimed in claim 2, wherein the ratchet ring includes teeth disposed annularly along the outer periphery thereof, and wherein the side hole is not connected with the teeth.

4. The wrench as claimed in claim 2, wherein the ratchet ring includes teeth disposed annularly along the outer periphery thereof, and wherein another end of the side hole, which is connected to the outer peripheral of the ratchet ring, has an edge only partially connected to the ring teeth.

5. The wrench as claimed in claim 2, wherein the side hole has an inner periphery including a wide section and a narrow section, wherein the wide section is adjacent to the outer periphery of the ratchet ring, wherein the narrow section has a radial width smaller than the wide section, wherein the narrow section is adjacent to the through hole, wherein the restrainer is arranged in the narrow section, and wherein the restrainer has an end, which is opposite to the long slot, aligned with a surface of the inner periphery between the wide section and the narrow section.

6. The wrench as claimed in claim 1, wherein the through hole has an inner periphery including a first inner surface and the side hole extends to the inner surface, wherein the outer periphery of the drive rod includes a first peripheral surface and the long slot extends on the first peripheral surface, wherein the inner periphery of the through hole includes a second inner surface and a positioning groove extends on the second inner surface and is radial to the axis, wherein the outer periphery of the drive rod includes a second peripheral surface and a first and a second hole extend on the second peripheral surface, wherein the first hole receives a first detent and a first resilient member, wherein the first resilient member has an end abutting the bottom of the first hole and another end abutting the first detent, wherein the second hole receives a second detent and a second resilient member, wherein the second resilient member has an end abutting the bottom of the second hole and another end abutting the second detent, wherein the first and the second detents selectively engages in the positioning groove, wherein when the drive rod is in the first position, the first detent corresponds to and engages in the positioning groove, and wherein when the drive rod is in the second position, the second detent corresponds to and engages in the positioning groove.

7. The wrench as claimed in claim 6, wherein the drive rod, along the axial direction of the axis, has an end provided with a first drive head and another end provided with a second drive head, wherein the first end of the long slot and the first detent are adjacent to the first drive head, wherein the second end of the long slot and the second detent are adjacent to the second drive head, and wherein the second drive head has a smaller width extending radially to the axis than the first drive head.

8. The wrench as claimed in claim 6, wherein the positioning groove has an inner peripheral edge which forms a concave surface, and wherein the first and the second detents are spherical.

9. The wrench as claimed in claim 1, wherein the long slot is long such that the side hole is partially closed by the body when the drive rod is selectively disposed in the first position or the second position.

10. The wrench as claimed in claim 1, wherein the restrainer 322 is a spring pin.
